(19) United States
(12) Patent Application Publication
(10) Pub. No.: US 2014/0184643 A1
(43) Pub. Date: Jul. 3, 2014

(54) Augmented Reality Worksite

(71) Applicant: CATERPILLAR INC., Peoria, IL (US)

(72) Inventor: Paul Friend, Morton, IL (US)

(73) Assignee: CATERPILLAR INC., Peoria, IL (US)

(21) Appl. No.: 13/728,511

(22) Filed: Dec. 27, 2012

(51) Int. Cl. G09G 5/377

(52) U.S. Cl. CPC G09G 5/377
USPC 345/633

(57) ABSTRACT

A system and method for coordinating machines and personnel about a physical worksite maintains worksite information associated with the physical worksite in a database. A position of an operator display device in the physical worksite is determined and augmentation content is generated from the stored worksite information associated with the determined position. The augmentation content can be displayed on an operator display device through which the physical worksite is also visible. The operator display device may be a heads-up display, a head mounted display or, in some embodiments, an off-board display device.

### TECHNICAL FIELD

This patent disclosure relates generally to the management and coordination of machines and personnel about a worksite and, more specifically, to a system utilizing augmented reality to implement such management and control.

### BACKGROUND

The development of worksites, such as in mining or landscaping, involves the communication and coordination of information about the worksite between the personnel and machines that are developing the worksite. This information may include the initial and desired topography of the worksite, the desired work to be done, the characteristics of materials or objects about the worksite, and the locations to and from which materials are to be moved or fixtures are to be placed. Furthermore, this information may change as the worksite develops. Various systems and methodologies have been developed to capture, coordinate and communicate that information, ranging from the simple use of flags or signs planted about the worksite to the implementation of positioning systems and telecommunications networks.

One developing technology in the information field is sometimes referred to as “augmented reality” or “augmented vision” in which a person's perception or view of the real world is augmented with additional informational input. That input may include additional information about the scene currently viewed by the person. U.S. Publication No. 2003/0014212 (“the '212 publication”) describes an augmented reality system that introduces additional input to augment the perception of a surveyor who is performing surveying tasks. The system described in the '212 publication utilizes a head-mounted apparatus and can determine the current position and direction of view of the surveyor. Based on the determined position and direction of view, the system accesses additional surveying information stored in a database and transmits the data to the head-mounted apparatus to augment the view through the apparatus. The system of the '212 publication, though, is limited in the sense of facilitating actual development of the survey site.

### SUMMARY

In an aspect, the disclosure describes a method of coordinating personnel or machines about a physical worksite. The method includes maintaining worksite information in a database in which the worksite information is associated with a plurality of specific locations in the physical worksite. A position in the physical worksite is determined and the determined positioned is associated with a specific location from among the plurality of specific locations in the physical worksite. Augmentation content is generated based on the specific location and the worksite information associated with the specific location. The method then displays the augmentation content on an operator display device.

In another aspect, the disclosure describes a system for coordinating machines and personnel about a physical worksite. The system includes a position determining sub-system that can determine a position of an operator display device in the physical worksite. The system also includes a virtual worksite sub-system that maintains a virtual worksite map representing the physical worksite. The virtual worksite map can include worksite information about the worksite. The system also includes an augmentation content generator developing augmentation content based on the position of the operator display device as determined and the worksite information.

In yet another aspect, the disclosure describes a method of dynamically coordinating machines and personnel about a physical worksite. The method involves storing worksite information in a database that is related to a physical worksite. The method determines a position of an operator display device at a specific location on the physical worksite and generates augmentation content from the worksite information in the database specifically associated with the specific location. The method then displays the augmentation content on the operator display device. According to the method, the worksite information may be updated in the database and the augmentation content can be regenerated from the worksite information as updated for redisplay on the operator input device.

### BRIEF DESCRIPTION OF THE DRAWINGS

FIG. 1 is a schematic diagram representing a worksite including machines and personnel performing various activities and tasks about the worksite and further including various communications and coordination networks.

FIG. 2 is a diagrammatical side plan view of an articulated truck with a schematic representation of an onboard controller associated with an operator display device in the form of a heads-up display (HUD) adapted for augmented reality capabilities.

FIG. 3 is a diagrammatical perspective view of an operator display device in the form of a head mounted display (HMD) that may be worn by an operator and is adapted for augmented reality capabilities.

FIG. 4 is a diagrammatical side plan view of a bulldozer with a schematic representation of an operator display device adapted for remote control and augmented reality capabilities.

FIG. 5 is a schematic block diagram illustrating the various informational inputs that may be processed by a controller and the various informational outputs from the controller to the operator display device.

FIG. 6 is a flowchart representing a possible series of steps or routines for generating and dynamically updating an augmented overlay for display on the operator display device.

FIG. 7 is a schematic diagram representing the worksite of FIG. 1 illustrating various informational inputs used to augment the view of the worksite through the operator display device.

### DETAILED DESCRIPTION

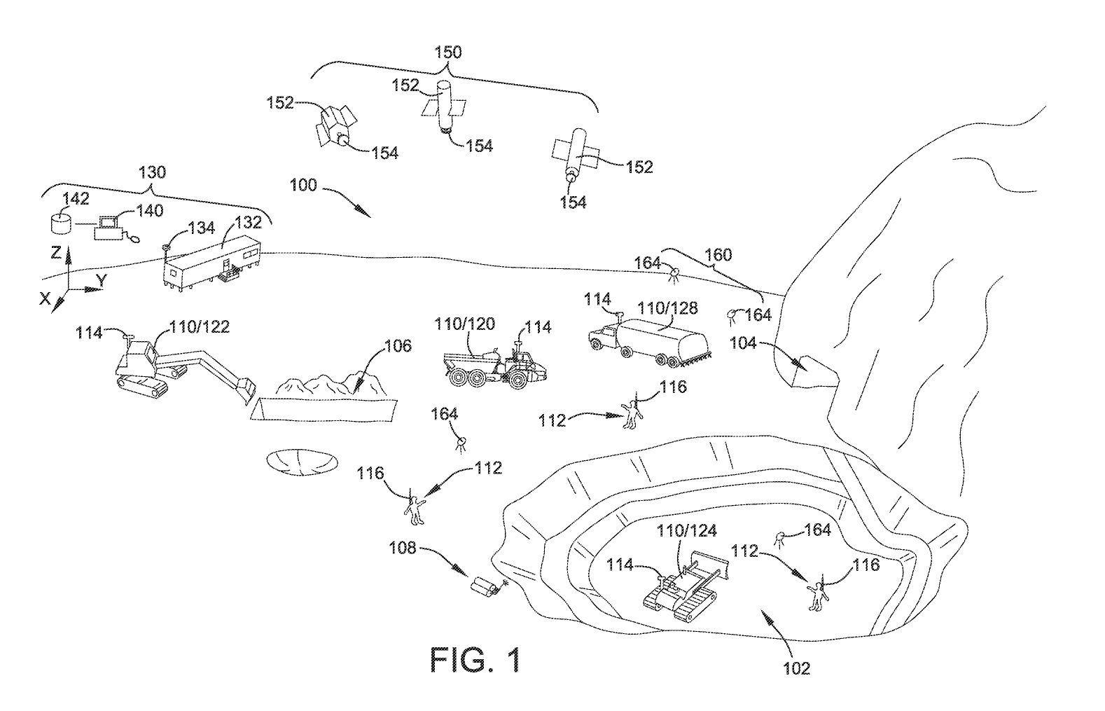

This disclosure relates generally to the coordination, direction, and control of various machines and personnel that may be working on various activities and moving about a worksite. Referring to FIG. 1, wherein like reference numbers refer to like features, there is illustrated an embodiment of a physical worksite 100 such as may be developed during mining operations or landscaping. Accordingly, various activities may be occurring simultaneously and dynamically on the physical worksite 100 such as open-cast or open-pit mining 102, longwall or tunnel mining 104, trenching or excavation 106, blasting operations 108 as is commonly done in mining, or any other suitable mining or landscaping operations. Although the foregoing activities are particularly suited to mining, it will be appreciated that the scope of the disclosure is broader and may apply to any large scale, coordinated activity such as building construction, road construction, landscaping, quarrying, and the like. Furthermore, as illustrated, the physical worksite may vary in topography in the X, Y, and Z coordinates that may represent latitude, longitude and elevation and that may change overtime as the worksite develops.

The operations being performed at the worksite 100 may be conducted by various machines 110 and personnel 112 moving about and altering the physical worksite 100. For example, in the illustrated physical worksite 100, machines 110 can include articulated trucks 120 that perform hauling and dumping operations, excavators 122 that can have articulating cranes to perform digging operations, bulldozers 124 that push material, and tankers 128 for carrying water or fuel. The foregoing machines, however, are by way of example only and the term “machine” as used herein may refer to any type of machine that performs some operation associated with an industry such as mining, construction, farming, transportation, or any other industry known in the art. For example, the machine may be an earth-moving machine, such as a wheel loader, dump truck, backhoe, material handler or the machine may be another type of working machine such as compactors, pavers, etc, or may be an over-the-road hauling type of machine. The personnel 112 can be supervisors, surveyors, operators, engineers and the like.

To facilitate communication between and among the machines 110 and personnel 112, each machine can include a machine transmitter/receiver 114 and the personnel may carry portable personnel transmitter/receivers 116 (represented as a vertical antenna for visibility). Any suitable form of communications networking can be used by the transmitter/receivers including, for example, the radio frequency (RF) signals. The communications network can be based around a central hub whereby each transmitter/receiver communicates signals to a central router that routes the signals onto the intended recipient or it can be a distributed network whereby each transmitter/receiver may communicate directly with every other transmitter/receiver.

To coordinate and control the activities and movement of the machines 110 and the personnel 112 about the physical worksite 100, a computerized or electronically implemented management system 130 can be based out of a fixed location or an immobile workstation 132. Located at the workstation 132 can be one or more computers 140 that implement the management system 130. The computers 140 can include a microprocessor, memory and input/output devices to interface with a user and further may be associated with a data repository or database 142, which in some embodiments may be centralized or shared with other computers or systems. To communicate with the machines 110 and personnel 112, the workstation 132 may include a system transmitter/receiver 134, possibly located at an appropriate location to increase its exposure to the physical worksite 100. While the illustrated embodiment shows the management system 130 implemented from a single workstation 132 and computer 140, in other embodiments, the system can be distributed about several locations at or remote from the worksite, and in some embodiments may be sustained by the interaction or electronic communications of the various mobile units carried by the machines and/or personnel.

To determine the positions of the various machine 110 and personnel 112, which may be mobile and move about the physical worksite 100, the management system 130 may be operatively associated with a position determining system that may be implemented in any suitable form. For example, the position determining system can be realized as a global navigation satellite system (GNSS) or global positioning satellite (GPS) system 150. In the GNSS or GPS system 150, a plurality of manmade satellites 152 orbit about the earth at fixed or precise trajectories. Each satellite 152 includes a positioning transmitter 154 that transmits positioning signals encoding time and positioning information towards earth. By calculating, such as by triangulation, between the positioning signals received from different satellites, one can determine their instantaneous location on earth. In the present embodiment, the machine transmitter/receivers 114 and personnel transmitter/receivers 116 can be configured to also receive the positioning signals from the positioning transmitters 154 but in other embodiments, a specific and dedicated GPS receiver may be utilized.

Instead of or in addition to the GPS system 150, a laser-based system 160 may be employed to determine the position of the machines 110 and personnel 112 about the worksite 100. In a laser-based system 160, one or more laser transmitters 164 that may be shaped as elongated tri-pod like structures are placed about the worksite 100. To transmit positioning signals, the laser transmitters 164 can transmit laser light in a 360° degree revolution from the laser transmitter that provides a plane of laser light with respect to a fixed reference point. The laser light may be received by the machine transmitter/receivers 114 and the personnel transmitter/receivers 116, which can be configured as or include an optical receiver. If the precise location of the laser transmitters 164 is known, it can be appreciated that the actual position of the machine 110 and/or personnel 112 within the physical worksite 100 can be determined. Such determination can be conducted based upon, as examples, the Doppler effect of the laser light or time periods between laser incidents on the transmitter/receivers.

Utilizing the position determining system, such as the GPS system 150 or laser-based system 160, the machines 110 and personnel 112 can determine their current positions about the physical worksite 100 and can communicate that information to the management system 130 through the system transmitter/receiver 134. In some embodiments, the management system 130 can also communicate directly with the position determining systems such as the GPS system 150 and/or the laser-based system 160 to receive information about the development of the physical worksite 100, such as work progress or modification of the topography. Using the positioning and possibly other information, the management system 130 can generate and relay various instructions to the various machines 110 and/or personnel 112 at the physical worksite 100. The instructions can include any suitable information helpful to the development of the physical worksite 100, such as coordination instructions that can direct the machines 110 and personnel 112 where to move or travel or what activity to perform. Further, because management system 130 can concurrently track the positions and movement of all the machines 110 and personnel 112 about the physical worksite 100, the coordination instructions can direct or suggest interaction between the machines and/or personnel.

The instructions may also include worksite information such as specific details about the physical worksite 100. Examples of worksite information may include the type of work being performed, the type or quality of material being mined or worked upon, or hazards and obstacles to avoid. Furthermore, because the precise location of the machines 110 and/or personnel 112 may be concurrently determined by the management system 130, the worksite information can be specifically customized or tailored for each machine and person based on their known or determined location and may be dynamically updated as the machines and people move about the worksite.

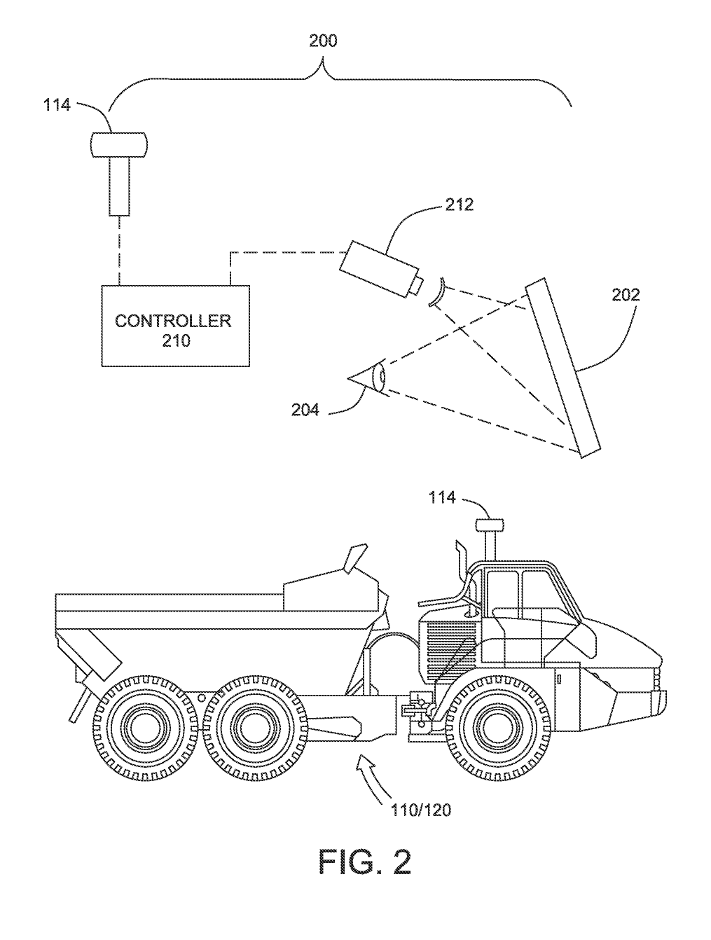

To display the coordination instructions, each machine 110 or person 112 may be equipped with an operator display device that is configured for augmenting the operator's perception of the physical worksite 100. As described above, augmented reality occurs when the viewer's current view of the physical, real world environment is augmented with generated input that can provide further information or input about the environment being perceived. For example, referring to FIG. 2, there is illustrated a machine 110, in particular, an articulated truck 120, equipped with an operator display device 200 configured to augment the environment perceived by the operator of the machine. The illustrated embodiment of the operator display device 200 is sometimes referred to as a “heads-up display” (HUD) because it enables the operators to view augmentation content without moving their head. The operator display device 200 may include an actual display 202 on which the augmented input can be shown. In the present example, the display 202 may be the windshield of the machine through which the operator typically views the physical worksite. Accordingly, the display 202 can be disposed in the operator's line of view as indicated by the location of the operator's eyes 204 in FIG. 2 that are directed towards the display 202. To enable the operator to see the environment, the display 202 will be typically be transparent but may be modified to also show the augmented input as described below.

To receive the augmented content, which may be generated by the off-board management system, the operator display device 200 may be associated with the machine transmitter/receiver 114 associated with the machine 110. Accordingly, the augmented content maybe embedded or encoded in the instructions or signals transmitted from the management system as described above. Those signals may be processed through an onboard controller 210 disposed on the machine 110 and communicating with the machine transmitter/receiver 114. The controller 210 can include microprocessors or other appropriate circuitry and can include memory or other appropriate data storage. Although the controller 210 illustrated in FIG. 2 is represented as a single unit, in other embodiments, the controller may be distributed among a plurality of distinct and separate units. Further, the controller 210 may be tasked with directing operation of several other features and systems of the machine.

The controller 210 can process the received signals and information to extract and generate the augmented input which is communicated to a projector 212 directed towards the display 202. The projector 212 may be an optical projection system, light emitting diode package, optical fibers, or other suitable projector for transmitting an image. The display 202 can be configured to reflect the image from the projector 212, for example, by thin film coating, tinting, polarization or the like. The display 202 also may be a beam splitter, as will be familiar to those of skill in the art. Thus, while the display 202 can be transparent to most wavelengths of light, it can reflect selected wavelengths such as monochromatic light back to the eyes 204 of the operator. Such a device is sometimes referred to as an “optical combiner” because it combines two images, the real environment and the image from the projector 212. The projected image may appear as an overlay superimposed on the view of the environment thereby augmenting the perceived environment.

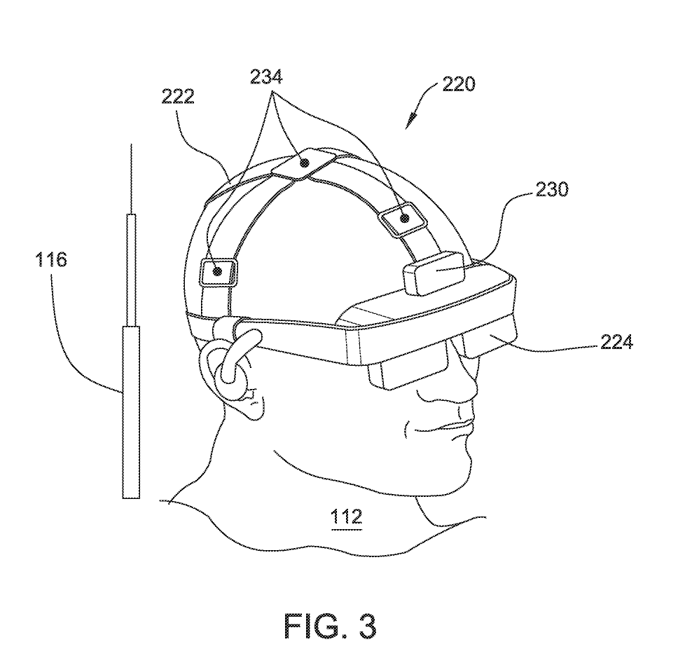

Of course, other suitable combiners may be used in accordance with the disclosure. For example, referring to FIG. 3, there is illustrated an operator display device in the form of a head mounted display (HMD) system 220 configured for augmented reality capabilities. The HMD system 220 includes an adjustable strap or harness 222 that allows the HMD system to be worn about the head of personnel 112 who may be present at the physical worksite. The HMD system 220 can include a visor or goggles with transparent lenses that function as the display 224 through which the wearer views the surrounding environment. The HMD system 220 can further include a scaled-down controller 230, that may include a processor or other electronics, and that can be in electronic communication with the personnel transmitter/receiver 116 carried by the person 112. The controller 230 can process the information signals received from the off-board management system and project them on the lenses, which can be optical combiners functioning as the display 224. Thus, the augmentation content can therefore be projected in the person's field of view as an overlay superimposed on the surrounding environment.

In a possible further feature, the HMD system 220 can be configured to receive augmented content not only specific to the location of the person 112, but specific to the person's line of view. For example, a plurality of sensors 234 can be disposed about the harness 222 to determine the orientation of the head of the wearer. For example, the sensors 234 may be Hall effect sensors that utilize the variable relative positions of a transducer and a magnetic field to deduce the direction, pitch, yaw and roll of an individual's head. The data obtained by these sensors 234 can be transmitted to the management system along with the more general positional data so that the management system may know the orientation of the person's field of view. The augmented content transmitted back to the HMD system 220 can be further particularized to the specific field of view, thereby increasing the sensitivity of the device.

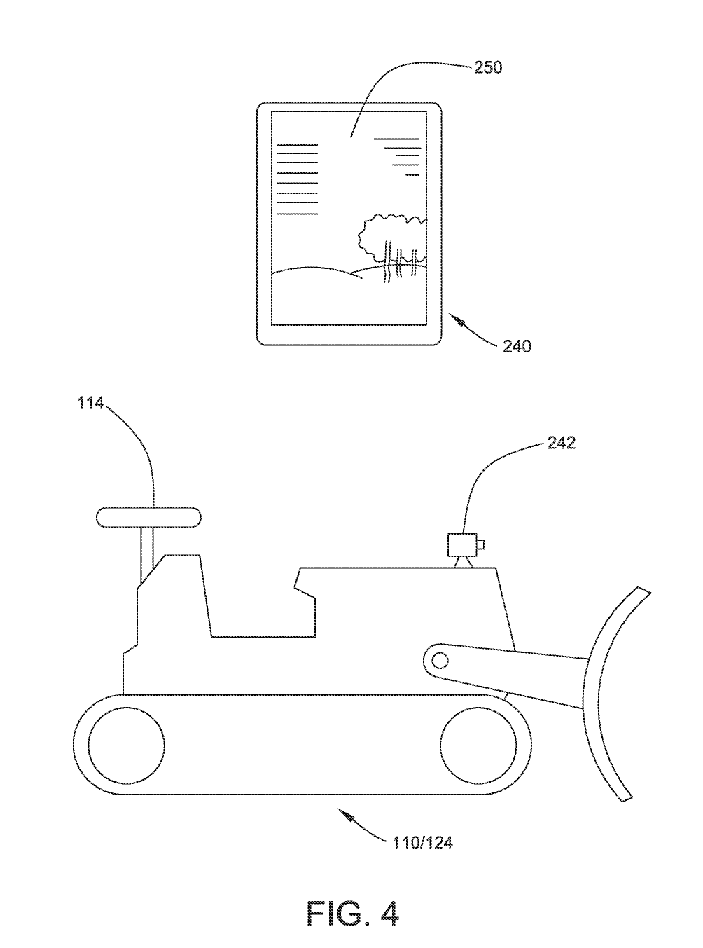

In other embodiments, the information from the management system may be used to augment an indirect display of the physical environment. For example, referring to FIG. 4, there is illustrated another embodiment of an operator display device 240 associated with a machine 110, such as a bulldozer 124, that may be remotely controlled by an operator. To facilitate remote control, the machine 110 may have a camera 242 mounted on it that records the immediate environment and transmits the image, using the machine transmitter/receiver 114, to a remote location. The view captured by the camera 242 can be displayed on a display 250, such as a liquid crystal display (LCD) or cathode ray tube (CRT), at a remote location from where the machine 110 is controlled. The captured image thus assists the operator in directing the machine as if the operator were onboard the machine. Augmentation information associated with the captured image of the worksite on the display 250 can be superimposed on the display 250 to augment the image. Thus, the operator can simultaneously view both the environment around the machine 110 and the input from the management system on the display 250.

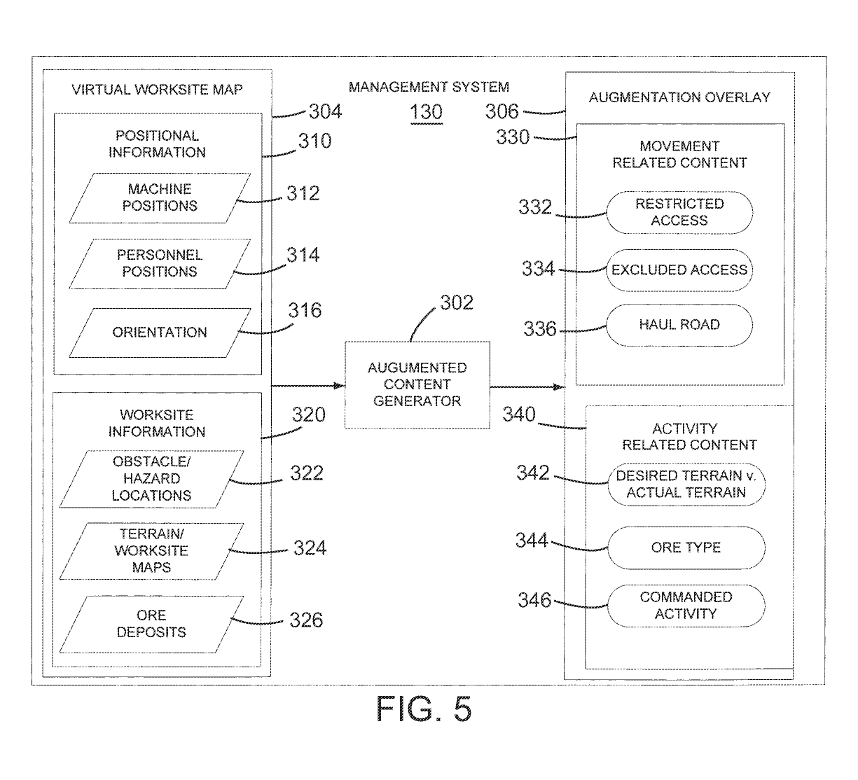

To generate information for the augmented content, the management system can process, filter and/or combine several informational items regarding the physical worksite. For example, referring to FIG. 5, there is illustrated a representation of a data processing routine 300 that the management system 130 can perform. Alternatively, the augmentation content generator can be embodied in the onboard controller associated with the operator display device. The routine 300 can be based around an augmentation content generator 302, which may be embodied as part of the management system 130 such as functions executed by the computer 140 in FIG. 1. The augmentation content generator 302 can receive inputs and process, develop or generate outputs that are communicated to the operator display devices. Inputs may include positional information 310 such as machine positions 312, personnel positions 314 and, where appropriate, orientation 316 of the direction of view. The management system 130 can maintain the positional information 310 in a database 142 associated with the computer or computers 140 of the management system 130. Further, the management system 130 may periodically or continuously update the positional information 310. The inputs may also include worksite information 320 such as, for example, the locations of obstacles or hazards 322, actual and/or desired worksite maps 324, and the locations or characteristics of ore deposits 326. The worksite information 320 can be assessed by empirical investigation of the physical worksite. In some embodiments, the database that maintains the positional information 310 and the worksite information 320 may be a relational database that maintains the information in a virtual worksite map 304 representing the physical worksite. The worksite information 320 may be associated with and retrievable by identifying specific locations in the physical worksite and their corresponding positions in the virtual worksite map 304.

The above inputs and other information can be communicated to the augmentation content generator 302 that generates outputs of augmentation content or information. The augmentation content may be generated as an augmentation overlay 306 intended to be superimposed over the operator display device. Because the management system knows or can readily determine the position of each machine or person via the positional information 310, the augmentation content can be customized for the intended machine or person.

Outputs, or augmentation content, can include coordination or movement related content 330 that is intended to direct or assist in the movement of machines and personnel about the physical worksite. For example, specific locations about the physical worksite may be designated as restricted access 332 limiting access to some or access excluded 334 excluding access to all. Other movement related content 330 can indicate hazards or obstacle locations or may indicate the presence of a haul road 336, which might be considered an area of permissible access for machines and personnel. Accordingly, movement related content 330 can be considered a form of coordination information described above.

Another output of the augmentation content generator 302 produced as augmentation content can be activity related content 340. Activity related content 340 can direct or instruct the machine operators and/or personnel to conduct certain activities at predetermined or specific locations about the physical worksite. An example of activity related content 340 can include information comparing the desired terrain to the actual terrain 342, which may be interpreted as an instruction to perform certain activities at that location. Another example may be information about the ore type 344, ore quantity or ore quality at a specific location that may indicate what mining operations to perform. Activity related content 340 can also be an order or instruction to perform a specific commanded activity 3468.

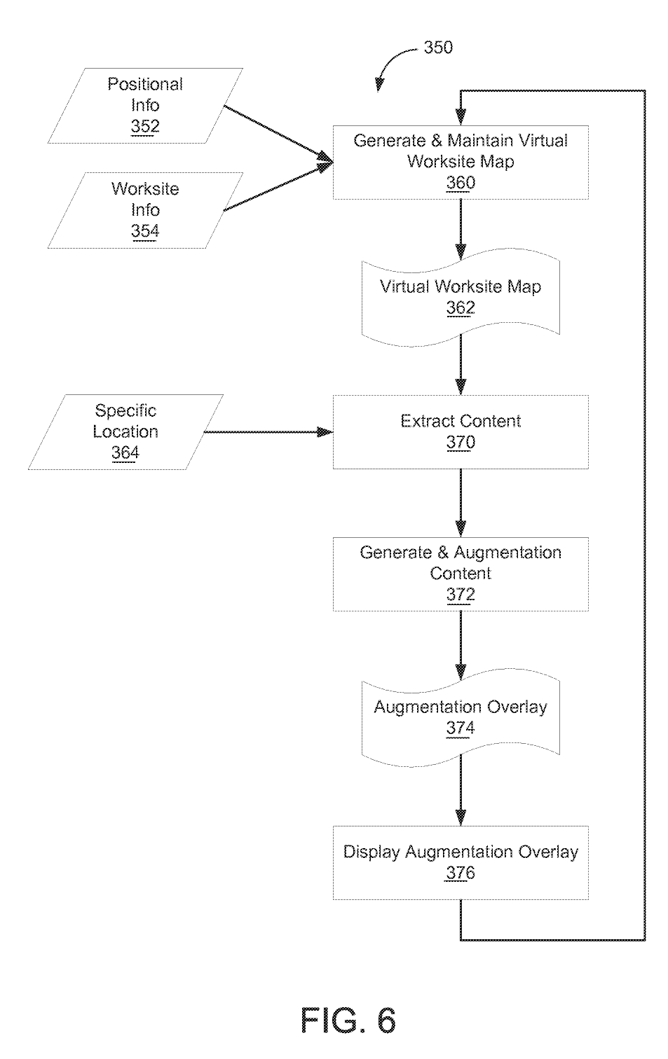

Referring to FIG. 6, there is illustrated another routine 350, depicted in the form of a flowchart, that can be executed by the management system to generate and refresh the augmented content to be displayed on the operator display devices. The routine 350 may be performed by the off-board management system, the onboard controller associated with the machine or personnel, or a combination of both. In the routine, the management system receives the positional information 352 regarding the locations and movement of the machines and personnel about the physical worksite and can receive other worksite information 354 regarding characteristics or desired development of the worksite. According to the routine 350, the management system can maintain this information in a virtual worksite map 362, corresponding to the physical worksite, in a virtual worksite map generation and maintenance step 360. The virtual worksite map 362 can be a digitalized rendering of the real, physical worksite and can associate the worksite information by specific locations with corresponding positions in the virtual worksite map. In various embodiments, the virtual worksite map 362 and the worksite information therein can be maintained as discrete regions associated with specific locations or may be maintained in a continuous integrated fashion.

The management system per the routine 350 can also monitor or receive the location of a particular machine or person at a specific location 364 in the physical worksite, for example, by longitude, latitude and elevational coordinates. The specific location 364 of the machine or person may be inferred as the location or position of the operator display device. The specific location 364 can be associated with a corresponding specific location in the virtual worksite map 362 and, in a content extraction step 370, the worksite information associated with the specific location can be extracted. The extracted worksite information, which may correspond to augmentation data, can be directed to a generation step 372 that generates the augmentation information, for example, in the form of an augmentation overlay 374. This can be done by the off-board management system or by the onboard controller associated with the operator display device. In a display step 376, the augmentation overlay 374 is projected on the operator display device to augment the individual's perception of the physical worksite.

Since the physical worksite is dynamically changing as machines and personnel move about and activities take place, the routine 350 can be configured to periodically or continuously repeat itself by returning to an earlier step. Accordingly, the routine 350 can regenerate, via the virtual worksite map generation and maintenance step 360, the virtual worksite map 362 based on newly determined or received machine and personnel positional information 352 and/or updated or newly determined worksite information 354. Hence, the virtual worksite map 362 may be sustained as a dynamic entity. Further, according to the routine 350, the management system can receive new or updated information regarding the specific location 364 of a particular machine or person so that the extraction step 370 may continue to extract pertinent data and information if the specific location changes.

### INDUSTRIAL APPLICABILITY

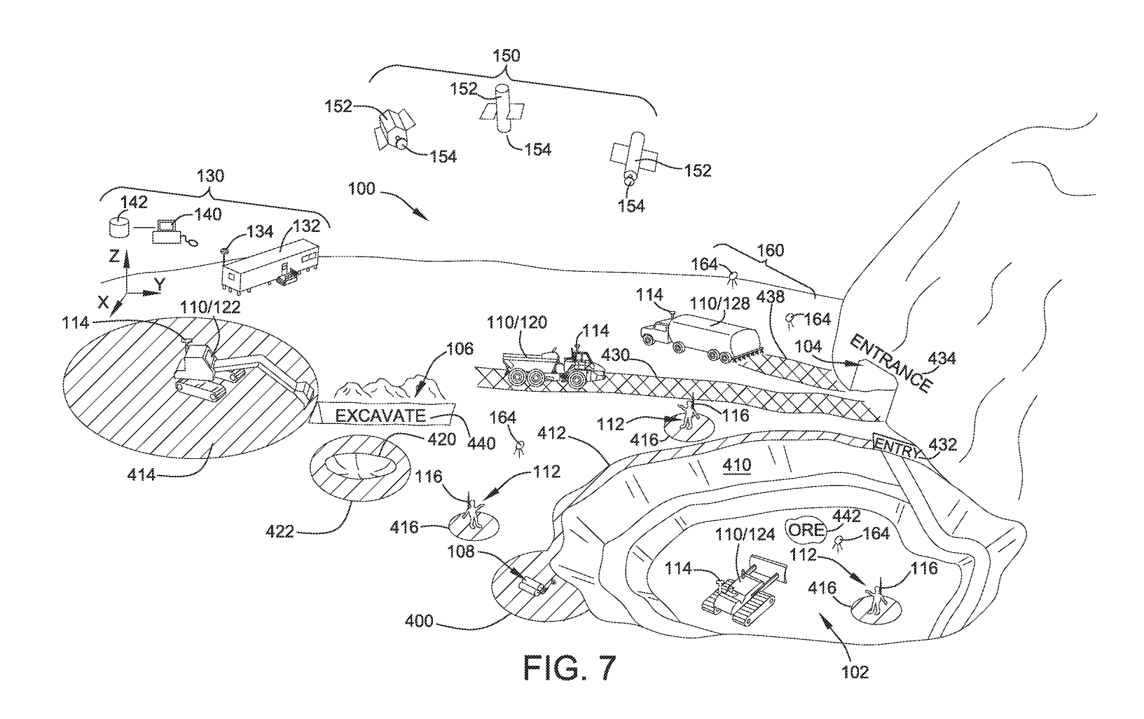

The present disclosure is applicable to the coordination and direction of machines and personnel about a worksite. Referring to FIG. 7, there is illustrated the physical worksite 100 of FIG. 1 as it might appear through an operator display device with augmented content projected as an augmentation overlay. The augmentation information may be presented on the operator display device as graphical or pictorial content as illustrated, as textual content, or in any other suitable form. The augmentation information can provide additional information or details that assist coordinating and guiding the machines 110 and personnel about the physical worksite 100, such as the movement related content described above. For example, certain areas of the physical worksite 100 may be designated as restricted or excluded access limiting movement of machines 110 and personnel 112 while other areas may be intentionally prepared for movement of machines and personnel and are thus permissible areas of access. As a specific example, excluded areas may present hazards or dangers that should be avoided, such as blasting operations 108. The management system 130 or in some embodiments an onboard controller may determine, based on worksite information previously stored in the database 142 associated with the management system computers 140, that a blasting operation 108 is or will be occurring and can generate augmentation data that demarcates the area around the blasting operation as an exclusion zone 400. An operator display device within or near the blasting operation 108 may superimpose the exclusion zone 400 over the view of physical worksite 100, for example, as hatching or an outline delineation in an appropriate color, thereby indicating to nearby personnel 112 that the otherwise indistinguishable exclusion zone should be vacated and avoided. As an example of the dynamic capabilities of the system, upon completion of blasting, the augmentation information can be updated to reflect that the blasting operation 108 has concluded and to remove the exclusion zone 400 from the augmented overlay.

Another type of exclusion zone may be the rim or ledge proximate a high wall 410 of an open-pit mining operation 102. The unsupported rim of the high wall 410 can collapse if unintended weight is on it. Accordingly, the management system 130 can maintain current locations of high walls 410, using previously input worksite and positional information, and can demarcate the areas or edges proximate the high walls as exclusions zones 412, which may be displayed appropriately as augmented content added to a machine's 110 or person's 112 relative perception of the physical worksite 100. The augmentation data can also warn of unseen or unobvious hazards, such as the area around an excavator 122, which may have an elongated articulating arm that can rotate 360°. While not readily apparent to the plain eye, the augmented perception may indicate the area around the excavator 122 as an exclusion zone 414. Other types of exclusion or heightened caution areas may include the caution areas 416 around personnel 112 or caution areas 420 around objects such as sinkholes 422 such as un-compacted material that may not be readily seen. Furthermore, as the conditions about the physical worksite 100 change, updated worksite information can be input to the management system 130 that can periodically or continuously update and refresh the augmentation content communicated to the operator display devices. Specifically, for example, the exclusion zones 412 located around the high walls 410 may change as in the open-pit mining operation develops or the exclusion zones 414 around the excavator 122 may shift if the excavator moves.

In addition to indicating restricted access or exclusion zones, the augmentation information can also provide movement related content to delineate intended areas for travel or movement about the physical worksite 100. For example, certain routes through the physical worksite may be designated as haul roads 430 that, in the absence of pavement, may not be readily apparent to the operator of a machine 110. The augmentation data presented on the operator display device may demarcate the haul road 430, using for example different shading or delineations of the boundaries of the haul road, and possibly the desired direction of travel to direct the machine 110 through the physical worksite 100. The computers 140 and database 142 can maintain a map of the haul roads 430 and use it to generate directions for the machines 110. Other directional information that may be conveyed to an operator of a machine 110 via augmented reality may be the indistinct entry point 432 of the open pit mine 102 or the possibly concealed entrance 434 of a tunnel mine 104. Another issue that might arise at worksites is controlling the quantity of dust the moving machines 110 may agitate. To suppress the dust, tankers 128 can create dust control routes 438 by spraying water along portions of the physical worksite 100. By monitoring the position and routes of the tankers 128, the indistinguishable dust control routes 438 may be accentuated for the operators of the machines by the augmentation data.

In addition to coordinating the movement of machines 110 and personnel 112 about the physical worksite 100, the management system 130 can generate and transmit instructions or directions about the desired activities that can occur about the worksite. For example, development of the physical worksite 100 may require excavation 106 to remove material from a specific location. The augmentation content can designate the appropriate area for excavation with an excavation indication 440 and can provide other instructions such as depth or quantity of material that should be removed. The excavation indication 440 can be presented as text instructions, outlines or otherwise. Another example of activity related information can be data concerning the type and location of ore intended for mining. For example, the presence and characteristics of a certain type of ore can be signified by an ore representation 442, which can be predetermined by sampling, can be presented as part of the augmented display for observation by the machines 110 and personnel 112 conducting the opening pit mining 102. The foregoing examples demonstrate the types of coordination and activity related information that may be presented through augmented reality; however, the disclosure contemplates other suitable types of coordination, motion and activity related data concerning worksite development through the use of augmented displays.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method of dynamically coordinating machines and personnel about a physical worksite, the method comprising:
storing worksite information in a database, the worksite information related to a physical worksite;
determining a position of an operator display device at a specific location on the physical worksite;
generating augmentation content from the worksite information in the database specifically associated with the specific location;
displaying the augmentation content on the operator display device;
updating the worksite information in the database; and
regenerating the augmentation content from the worksite information as updated.

2. The method of claim 1, wherein the augmentation content includes movement information delineating areas of permissible and/or restricted movement in the physical worksite.

3. The method of claim 2, wherein the augmented content delineates exclusions zones, restricted access areas, haul roads, dust suppression roads, entrances and exits.

4. The method of claim 1, wherein the augmentation content includes activity information about activities occurring at the specific location in the physical worksite.

5. The method of claim 1, wherein operator display device is selected from a group consisting of a head mounted display, a heads-up display and an off-board display.

6. The method of claim 5, wherein the head mounted display and the heads-up display include a transparent display on which the augmentation content is displayed.

7. The method of claim 1, wherein the worksite information is maintained in a virtual worksite map.

8. The method of claim 7, wherein the virtual worksite map is maintained in an off-board computer remote from the operator display device.

9. The method of claim 7, wherein the virtual worksite map is maintained in a controller proximate the operator display device.

10. The method of claim 1, wherein the step of generating the augmentation content occurs on an off-board computer remote from the operator display device.

11. The method of claim 1, wherein the step of generating the augmentation content occurs on a controller proximate to the operator display device.

12. A system for coordinating machines and personnel about a physical worksite, the system comprising:
a position determining sub-system determining a position of an operator display device in the physical worksite;
a virtual worksite sub-system maintaining a virtual worksite map representing the physical worksite, the virtual worksite map including worksite information; and
an augmentation content generator developing augmentation content based on the position of the operator display device and the worksite information.

13. The system of claim 12, wherein the operator display device is selected from a group consisting of a head-mounted display, a heads-up display, and an off-board display.

14. The system of claim 13, wherein the head-mounted display and the heads-up display include a transparent display on which augmentation content is displayed.

15. The system of claim 14, wherein the augmentation content generator is included in an off-board computer remote from the operator display device.

16. The system of claim 15, wherein the augmentation content generator is included in a controller proximate to the operator display device.

17. A method of coordinating personnel and/or machines about a physical worksite, the method comprising:
maintaining worksite information in a database, the worksite information associated with one of a plurality of specific locations in the physical worksite;
determining a position in the physical worksite;
associating the position determined with a specific location from among the plurality of specific locations in the physical worksite;
generating augmentation content based on the specific location and the worksite information associated with the specific location; and
displaying the augmentation content on an operator display device.

18. The method of claim 18, wherein the augmentation content includes movement information delineating areas of permissible and/or restricted movement in the physical worksite.

19. The method of claim 19, wherein the augmented content delineates exclusions zones, restricted access areas, haul roads, dust suppression roads, entrances and exits.

20. The method of claim 19, wherein the operator display device is selected from a group consisting of a head mounted display, a heads-up display and an off-board display.
